(19) United States
(12) Patent Application Publication
(10) Pub. No.: US 2021/0214548 A1
(43) Pub. Date: Jul. 15, 2021

(54) PHENOLIC-BASED METAMATERIALS AND METHODS OF FORMING PHENOLIC-BASED METAMATERIALS

(71) Applicant: ALBERTELLI, Aldino, Dublin 2 (IE)

(72) Inventor: ALDINO ALBERTELLI, DUBLIN (IE)

(21) Appl. No.: 17/059,799

(22) PCT Filed: May 30, 2019
(86) PCT No.: PCT/GB2019/051471

§ 371 Date: Nov. 30, 2020

(30) Foreign Application Priority Data
May 30, 2018 (GB) 1808849.2

(51) Int. Cl. C08L 61/06; C08K 3/22; C08G 8/10; B32B 5/02; C08J 3/21; C08K 7/14; B32B 15/098; B32B 15/20

(52) U.S. Cl. CPC C08L 61/06; C08K 3/22; C08G 8/10; B32B 5/022; B32B 5/024; C08J 3/212; B32B 2250/40; B32B 15/098; B32B 15/20; C08K 2003/2227; B32B 2262/101; B32B 2305/72; C08K 7/14

(57) ABSTRACT

The present invention relates tophenolic-based metamaterials and methods for preparing phenolic-based materials. The present invention also relates to composites formed from phenolic-based metamaterials. More specifically, the present invention is concerned with phenolic materials formed by heating phenolic resin mixtures.

The present invention relates to phenolic-based metamaterials and methods for preparing phenolic-based materials. The present invention also relates to composites formed from phenolic-based metamaterials. More specifically, the present invention is concerned with phenolic materials formed by heating phenolic resin mixtures.

The term “phenolic resin” describes a wide variety of resin based products that result from the reaction of phenols and aldehydes. Traditionally, phenolic resins are formed by reacting phenols with formaldehyde under either acidic or basic conditions, depending on the product required. When a phenolic resin is formed using a basic catalyst and an excess of formaldehyde (>1 equivalent per phenol equivalent) a thermosetting resin, or “resole”, is formed. Typical basic catalysts include hydroxides of alkali metals, such as sodium, potassium, or lithium. Alternatively, phenolic resins can be formed using an acid catalyst producing a pre-polymer (novolac) which can be moulded and subsequently cured.

Typically, when selecting materials for their improved mechanical properties, such as strength and hardness, a trade-off must be made between the weight of a material and its mechanical properties. For example, aluminium is substantially less dense than steel but may not meet the mechanical requirements for certain applications. Thus, in some cases, ideal mechanical properties must be sacrificed where low weight is a priority or vice versa. Therefore, there is a need for lightweight materials having improved mechanical properties.

According to a first aspect of the present invention, there is provided a method for preparing a phenolic-based metamaterial, the method comprising providing:

(i) 1 part by weight of a phenolic resin;

(ii) 2 to 4 parts by weight of a transition metal hydroxide and/or aluminium hydroxide;

mixing components (i) and (ii) to form a phenolic resin mixture; and

heating the phenolic resin mixture at a temperature of greater than 200° C. to form the phenolic-based metamaterial.

It has been surprisingly found that by heating the phenolic resin mixture formulated as described herein to a temperature greater than 200° C., the phenolic resin is advantageously able to form a phenolic material that is unusually hard. In particular, the phenolic resin mixture may be heated to temperatures at which conventional phenolic resins would typically burn to ash and instead form a hard, ceramic-like material whilst substantially avoiding burning.

Without wishing to be bound by any particular theory, it is believed that the particular formulation of the phenolic resin mixture allows it to undergo a surprising physical change when subjected to high temperatures, which leads to unusual hardening of the material to a ceramic-like form instead of burning to ash in the manner of a typical phenolic resin mixture. In particular, it believed that the metal hydroxide may decompose to metal oxides in situ to form a ceramic-like material in combination with the phenolic resin. The phenolic resin may be carbonized at the elevated temperature, leading to a ceramic-like material formed by C—C bonds in the structure, which are thought to combine with the metal oxides to form a surprisingly hard material.

The term “phenolic-based metamaterial” as used herein will be understood to refer to a phenolic resin mixture that has been modified so as to change its mechanical properties beyond that which is achieved by conventional curing of the resin. It will be appreciated that such materials may no longer have a structure or overall composition that resembles a conventional phenolic resin material. For example, the phenolic-based metamaterial may at least in part comprise a carbonized ceramic material.

The exact hardness of the phenolic-based metamaterial may vary depending on the particular formulation of the phenolic resin mixture and the specific method by which it is produced.

In some preferred embodiments, the phenolic-based metamaterial may have a hardness of 200 HV (Vickers hardness) or greater, for example 300 HV or greater, or even 400 HV or greater as measured on the Vickers scale, for example by standard methods ISO 6507-1:2018 or ASTM E384-17. In some embodiments, the phenolic-based metamaterial may have a hardness of from about 300 to about 600 HV.

The phenolic-based metamaterial of the present invention may be considerably less dense than commonly used materials having similar hardness. Thus, the phenolic-based metamaterial may advantageously provide a low weight material having unusually high hardness.

In addition, prior to heating the phenolic resin mixture to greater than 200° C., the phenolic resin mixture can be easily shaped and manipulated as required, while materials having high hardness such as ceramics or hardened metals are not as easily shaped and manipulated. Thus, in some preferred embodiments, the phenolic resin mixture is moulded or shaped prior to the step of heating the phenolic resin mixture to form the phenolic metamaterial.

Preferably, 2.5 to 3.5 parts by weight of the metal hydroxide are provided in (ii).

As will be appreciated, the number of hydroxide groups relative to each metal atom of the metal hydroxide may vary, for example depending on the oxidation state of the metal or on any additional groups associated with the metal. In preferred embodiments, the metal hydroxide is of the formula M(OH)₃, wherein M is a metal.

In accordance with the present invention, the metal hydroxide is one or more of a transition metal hydroxide or aluminium hydroxide. Preferably, the metal of the metal hydroxide is one or more of scandium, vanadium, chromium, manganese, iron, cobalt and aluminium.

In particularly preferred embodiments, the metal hydroxide is aluminium hydroxide.

Without wishing to be bound by any particular theory, it is believed thatwhen aluminium hydroxide in the phenolic resin mixture is heated, the aluminium hydroxide decomposes to aluminium oxide (alumina). The aluminium oxide may then combine with the phenolic resin and the other aluminium oxide particles to form the hard phenolic-based metamaterial. The aluminium oxide may form a sintered structure during its formation when the aluminium hydroxide decomposes and may contain at least some regions where forms of crystalline aluminium oxide, such as corundum, are formed.

The metal hydroxide may be in any suitable form such that it can be dispersed and mixed with the resin, for example, in the form of a ground powder. In preferred embodiments, the metal hydroxide comprises particles having a particle size distribution with a D90 from 50 to 70 μm, and/or a D50 from 15 to 35 μm, and/or a D10 from 1 to 10 μm. More preferably, the metal hydroxide comprises particles having a particle size distribution with a D90 from 55 to 65 μm, and/or with a D50 from 20 to 30 μm, and/or with a D10 from 2 to 5 μm.

It will be understood by a person of skill in the art that, for example, a D90 of 70 μm refers to 90% of the particles by mass having a particle size of less than 70 μm. Similarly, D50 refers to 50% of the particles and D10 refers to 10% of the particles.

Preferably, at least about 50% of particles of the metal hydroxide have a particle size of from 10 to 50 μm, preferably at least about 70% of particles of the metal hydroxide have a particle size of from 10 to 50 μm.

The mixing of the phenolic resin and the metal hydroxide described herein may be conducted in the presence of a viscosity controlling agent. Preferably, the mixing is conducted in the presence of 0.2 to 1 parts by weight, relative to the phenolic resin, of a viscosity controlling agent, more preferably, the mixing is conducted in the presence of 0.4 to 0.9 parts by weight of the viscosity controlling agent.

Suitable viscosity controlling agents may be selected from one or more of butanol, chloroform, ethanol, water, acetonitrile, hexane, and isopropyl alcohol. In a preferred embodiment, the viscosity controlling agent is water.

It will be appreciated that the amount of viscosity controlling agent used may be dependent on the intended use of the phenolic resin mixture. Where the phenolic resin mixture should hold its shape, for example to form a layer, it needs to be of a viscosity suitable for forming such a shape, for example, by an extrusion or rolling process. Likewise, where the phenolic resin mixture is intended to impregnate a material, such as a woven fibre mat or textile, the viscosity must be such that the phenolic resin mixture can flow around the fibres of the mat or textile and produce an impregnated material. It is considered that the controlling of the viscosity is within the knowledge of the person of skill in the art.

The viscosity controlling agent may be provided as a separate component of the phenolic resin mixture, or may, at least in part, be provided with the phenolic resin, for example as part of a solution or suspension of the resin in a liquid viscosity controlling agent.

By way of example, the phenolic resin mixture may have a dynamic viscosity range of from 200 to 10,000 mPa·s at 20° C., as measured according to the standard method ISO 3219:1993.

The phenolic resin used in accordance with the present invention may be any suitable resin and such resins are well-known to the person of skill in the art. By way of example, suitable phenolic resins include those obtained from Satef Huttenes-Albertus.

In preferred embodiments, the phenolic resin is a phenolic resole resin. Preferably, the phenolic resole resin is a resin having a low formaldehyde content. For example, in preferred embodiments, the phenolic resole resin includes less than 10% by weight of free formaldehyde, preferably less than 1% by weight, more preferably less than 0.5% by weight, for example less than 0.1% by weight.

The phenolic resin mixture may be produced by mixing the components so as to form a generally homogeneous distribution of the components throughout the mixture. Any known method may be used to produce the general homogeneous distribution, such as high-shear mixing.

The length of time required to produce a generally homogeneous distribution of the components is dependent on, amongst other things, the amount of each component added, the viscosity of the components and the method of mixing used. In general, a substantially homogeneous distribution of the components can be formed within 5 minutes to 2 days, preferably 10 minutes to 1 day, more preferably within 15 minutes to 10 hours.

As discussed, the phenolic resin mixture is heated to a temperature greater than 200° C. In this way, the phenolic resin mixture is heated to temperatures beyond those which may typically be used for curing the resin and even at temperatures where substantial charring of the phenolic resin may be expected. At these temperatures, the phenolic resin mixture undergoes a surprising physical change to produce a hard, ceramic-like material.

In preferred embodiments, the heating of the phenolic resin mixture is at a temperature of around 300° C. or greater, preferably around 400° C. or greater. It has been surprisingly found that heating to temperatures greater than 400° C. can substantially avoid burning and ash formation. Preferably, heating of the phenolic resin mixture is at a temperature of around 500° C. or greater, for example 600° C. or greater. It has also been found that heating to a temperature of about 1000° C. or greater may be particularly effective for formation of the phenolic-based metamaterial.

Surprisingly, when the phenolic resin mixture is heated to high temperatures at which conventional phenolic resins would be expected to burn to ash (typically around 300° C. or greater) the resin does not burn to ash substantially and instead forms a hard, ceramic-like phenolic-based metamaterial. In addition, it has been found that the amount of ash or burning that occurs is surprisingly reduced at higher temperatures.

The heating may be achieved by any suitable method or means.

For example, the heating may be conducted by placing the phenolic resin mixture inside an oven at the appropriate temperature.

The heating may be conducted using a stream of hot air onto the phenolic resin mixture or using a flame from an instrument such as a blowtorch. Alternatively, the heating may be conducted by any direct or indirect application of heat by other suitable means.

It will be appreciated that the length of time for the heating may be any suitable time period and may depend on the amount of the phenolic resin mixture to be heated and the particular arrangement of the phenolic resin mixture, for example the thickness of a layer of the mixture. The amount of time may also depend on the particular temperature applied and the method by which the phenolic resin mixture is heated.

In preferred embodiments, the phenolic resin mixture is heated for at least about one minute, preferably at least about 5 minutes, more preferably at least about 10 minutes, for example at least about 15 minutes.

In some embodiments, the phenolic resin mixture is heated for longer time periods, for example at least 30 minutes, at least 1 hour or at least 2 hours. In some instances the phenolic resin mixture may be heated for even longer time periods, for example at least 12 hours, at least 24 hours, or at least 48 hours.

In preferred embodiments, the step of heating the phenolic resin mixture at a temperature of greater than 200° C. is conducted in the substantial absence of oxygen.

A substantial absence of oxygen as referred to herein will be understood to mean that the heating of the phenolic resin mixture is conducted in an atmosphere comprising 10% v/v oxygen or less, preferably 5%v/v or less, for example 1%v/v or less or even 0.5% v/v or less.

In some embodiments, the heating may be conducted without exposure to an external atmosphere, for example where the phenolic resin mixture is present in a space between non-porous substrates. It will be appreciated that in such cases, a portion of the phenolic resin mixture may be exposed at its edges but a large portion of the phenolic resin mixture will be contained without exposure to the atmosphere.

In some embodiments, the heating may be conducted under pressure, for example the material may be pressed during the heating step using a suitable pressing means.

The method may further comprise adding fibres to the phenolic resin mixture. The fibres may be woven or unwoven.

It will be understood that the fibres will be added to the phenolic resin mixture prior to the step of heating to 200° C. or greater. The fibres may, for example, be added to the components (i) and (ii) during the mixing step.

The fibres may be short fibres, or may be longer fibres. The fibres may be loose, for example, the fibres may be arranged in a uni- or multi-directional manner. The fibres may be part of a network, for example woven or knitted together in any appropriate manner. The arrangement of the fibres may be random or regular.

Fibres may provide a continuous filament winding. More than one layer of fibres may be provided. The fibres may be in the form of a layer. Where the fibres are in the form of a layer, they may be in the form a fabric, mat, felt or woven or other arrangement.

In an embodiment, the fibres may be selected from one or more of mineral fibres (such as finely chopped glass fibre and finely divided asbestos), chopped fibres, finely chopped natural or synthetic fibres, and ground plastics and resins in the form of fibres.

In addition, the fibres may be selected from one or more of carbon fibres, glass fibres, aramid fibres and/or polyethylene fibres, such as ultra-high molecular weight polyethylene (UHMWPE).

The fibres may include short fibres. The fibres may of a length of 5 cm or less.

Where present, the fibres may be added to the phenolic resin mixture in a ratio of resin to fibre of 6:1 to 1:3, such as a ratio of from 4:1 to 1:1.

It will be appreciated that the stage of the process at which the fibres are added to the phenolic resin mixture or components thereof may depend on the nature of the fibres. For example, if the fibres cannot be mixed in the same way as the other components then the components of the mixture may be mixed and then combined with the fibres. For example, short fibres may be mixed into the phenolic resin mixture, while for a layer of fibres it may be necessary to impregnate the layer with the phenolic resin mixture.

The method may further comprise providing one or more fillers in addition to the metal hydroxide in the phenolic resin mixture.

Preferably, the filler is present in a ratio of total filler to the phenolic resin in an amount of 2.5:1 and greater, wherein the amount of the metal hydroxide (ii) is considered to be included as a filler for this purpose.

In some embodiments, the filler may be present in an amount of 3:1 and greater, and preferably in an amount of 3.5:1 and greater. It will be appreciated that the amount of filler which is added is dependent, in some instances, on the intended use of the material being prepared. It may also be possible to increase the amount of filler whilst still maintaining the desired properties of the material. Accordingly, the amount of filler present may also be in an amount of 5:1 and greater where applicable.

In some embodiments, the amount of filler may be present in an amount of 20:1 and less, such as in an amount of 10:1 and less.

In general, the fillers used in the phenolic resin mixture described herein may be any particulate solid which insoluble in the resin mixture.

As will be appreciated, it is preferable that the filler is inert to the rest of the components of the phenolic resin mixture.

The fillers used may be organic or inorganic materials. For some embodiments, it is preferable for the filler to be an inorganic material.

Suitable fillers for use in the material described herein may be selected from one or more of clays, clay minerals, talc, vermiculite, metal oxides, refractories, solid or hollow glass microspheres, fly ash, coal dust, wood flour, grain flour, nut shell flour, silica, ground plastics and resins in the form of powder, powdered reclaimed waste plastics, powdered resins, pigments, and starches. In particular, fillers may include sand and/or silica. In some embodiments the filler may comprise iron oxide.

In preferred embodiments, the filler comprises sand and/or silica.

In some preferred embodiments, the filler comprises a metal, for example, aluminium. The metal will typically be in particulate form, for example in the form of a powder or shavings.

In addition to the other components described herein, the phenolic resin mixture may further comprise ethylenediaminetetraacetic acid (EDTA). However, it is not in anyway essential to the present inventions.

In preferred embodiments, the fillers do not substantially comprise silicates and/or carbonates of alkali metals. This is due to the fact that solids having more than a slightly alkaline reaction, for example silicates and carbonates of alkali metals, are preferably avoided because of their tendency to react with the acid hardener. However, solids such as talc, which have a very mild alkaline reaction, in some cases because of contamination with more strongly alkaline materials such as magnesite, are acceptable for use as fillers.

It will be understood that the fillerwill be added to the phenolic resin mixture prior to the step of heating to 200° C. or greater. The filler may, for example, be added to the components (i) and (ii) during the mixing step.

In preferred embodiments, the method further comprises applying the phenolic resin mixture to a substrate prior to heating the mixture at a temperature of greater than 200° C. to form a composite material.

The substrate may be any suitable material.

In preferred embodiments, the substrate is in the form of a sheet. The phenolic resin mixture is preferably distributed in a layer on a surface of the sheet.

In some preferred embodiments, the substrate comprises a shaped or profiled surface. In such embodiments, the phenolic resin mixture may be shaped or moulded to the substrate before the step of heating the phenolic resin mixture to form the phenolic metamaterial. In this way, a phenolic-based metamaterial may be produced having a particular shape that can be varied depending on the desired end use. In such embodiments, the phenolic-based metamaterial may remain bonded to the shaped substrate following the heating step. In other embodiments, the substrate may comprise a mould from which the phenolic resin mixture is removed before the heating step or from which the phenolic-based metamaterial is removed after the heating step.

Preferably, the phenolic resin mixture is applied to substantially all of the substrate.

The phenolic resin mixture as described herein may act as an adhesive so as to bond to the substrate.

In some instances, the phenolic resin mixture may comprise a release agent for aiding release of the resin mixture from a substrate or mould where desired. Any suitable release agent may be used. In preferred embodiments the release agent comprises a metal-fatty acid salt, for example a stearate salt. In preferred embodiments the release agent comprises zinc stearate, calcium stearate or magnesium stearate, preferably zinc stearate.

Preferably, the amount of release agent that is present may be less than 1 wt. % relative to the content of the phenolic resin, more preferably less than 0.5 wt. % relative to the content of the phenolic resin, such as less than 0.2 wt. %.

In preferred embodiments, the phenolic resin mixture is substantially free of release agents, such as the release agents described previously. By substantially free, it is meant that the amount of any release agent present is negligible in terms of the overall effect that it has on the phenolic resin mixture.

In some embodiments the substrate comprises a thermally conductive material, such that heat applied to the substrate may be distributed across the substrate and the phenolic resin mixture applied to the substrate.

Where a thermally conductive substrate is used, the substrate may advantageously distribute heat across the substrate and to the phenolic resin mixture applied to the substrate, which may improve the uniformity of the material after heating.

Preferably, the substrate comprises a metal. In a particularly preferred embodiment, the substrate comprises aluminium.

Where a heat sensitive substrate is used, for example a substrate that would typically melt under the heating conditions, the phenolic resin mixture may advantageously impart heat-resistance to the substrate beyond the normal heat-tolerance of the substrate. For example, a substrate may not melt or catch fire when subjected to a temperature at which this would usually happen, allowing formation of the phenolic-based metamaterial.

Metal substrates may also be in the form of particulate material applied to the surface of the phenolic resin mixture. For example, metal powder or shavings may be applied to the surface of the resin mixture before heating.

In some embodiments, the substrate may include surface formations for keying with the phenolic resin mixture. This can improve the bond between the substrate and the phenolic resin mixture.

The substrate may be formed from natural materials such as wood and cellulose derived products.

The substrate may also be formed from well-known polymeric materials such as polyvinylchloride, polyurethane, polyethylene, polystyrene, phenolics, syntactic polymers and honeycombs.

The substrate may additionally be formed from inorganic materials such as ceramics, glasses and carbon based materials.

The substrate materials used may be foamed or unfoamed.

The foam substrate materials may be a crushable material such that, during the application of pressure, the surface of the substrate is moulded.

Preferred foamed materials include foamed phenolic resin or foamed polyurethane resin.

Where the material is foamed it may be open-celled or close-celled.

In a preferred embodiment, the material is an open-cell foam.

Suitable open-cell foams include foamed phenolic resin for example, as manufactured under the brand Acell by Acell Industries Limited.

A particular advantage of using such an open-celled material is that at least a portion of the phenolic resin mixture may flow into the open-cells of the substrate.

It will be appreciated that the application of heat may improve the flow of the phenolic resin mixture into the open-cells of the substrate.

Preferably the phenolic resin mixture and substrate are such that the material only partly flows into the substrate during the pressing step so that good bonding between the phenolic resin mixture and the substrate is obtained while retaining a suitable thickness for bonding to a second substrate and providing the required mechanical and other properties of the composite formed.

Preferably the method further comprises the step of applying a second substrate to the phenolic resin mixture, for example so that the mixture bonds to the second substrate.

The method may comprise the step of applying a layer of the phenolic resin mixture between two substrates before heating to a temperature greater than 200° C. to form the composite. For example, the phenolic resin mixture may be applied so as to form a layer between two aluminium sheets.

It has been found that by heating a composite comprising the phenolic resin mixture applied between two aluminium sheets to a temperature of greater than 200° C., the resin mixture forms the surprisingly hard ceramic-like material in the space between the sheets. In this way, low-weight aluminium composites having advantageous mechanical properties may be produced according to the present invention.

In some embodiments, a layer of the phenolic resin mixture between two substrates may be pressed using a heated press such that the phenolic resin may be at least partially cured during the pressing step.

In some embodiments, substantially lower pressures may be used or a press may be omitted altogether. For example the phenolic resin mixture and substrate may be pressed together using vacuum, for example by vacuum bagging, or pressed manually.

The second substrate may be substantially as described herein in relation to the first substrate.

In some embodiments, both substrates may be made from the same material. In other embodiments, the substrates may be different. It will be appreciated that the particular arrangement will depend on the intended use of the composite material.

In a preferred embodiment, both substrates comprise a sheet of metal, preferably aluminium, and the method comprises the step of applying the phenolic resin mixture to provide a layer of the mixture between the sheets.

In some preferred embodiments, the method may comprise providing a layer of the phenolic resin mixture between an aluminium sheet and a second different substrate, for example a polymeric foam substrate.

It will be appreciated that more than two substrates may be combined with the phenolic resin mixture to form a composite. For example, a layered composite may comprise more than two substrate sheets having a layer of the phenolic resin mixture between each of the substrates.

It will also be appreciated that where multiple substrate layers are used, one or more layers may be bonded together by other means than the phenolic resin mixture.

The method may preferably further comprise the step of causing or allowing the phenolic resin mixture to at least partially set prior to heating the mixture at a temperature of greater than 200° C.

In this way, the phenolic resin mixture may be cured to bond substrates in a composite together, after which the heating step to greater than 200° C. can advantageously produce the phenolic-based metamaterial as part of the composite.

It will be appreciated that the phenolic resin mixture may be applied to one or more substrates as described herein before or after causing or allowing the mixture to at least partially set.

Preferably, the step of causing or allowing the phenolic resin mixture to at least partially set comprises heating the phenolic resin mixture to a suitable temperature.

By way of example, the phenolic resin mixture may be heated to a temperature of at least 50° C. In some embodiments, the phenolic resin mixture is heated to a temperature between 100 and 200° C.

By way of further example, the phenolic resin mixture may be heated for a time period of at least one minute. In general, it will be appreciated that the time necessary to obtain the desired technical effect will depend on the amount of resin, the temperature, as well as the thickness of the material to be cured.

In some embodiments, the steps of causing or allowing the phenolic resin mixture to at least partially set and heating to greater than 200° C. may be at least partially combined or may overlap such that the phenolic resin mixture is cured and modified in one continuous heating step. For example, the phenolic resin mixture may first be heated at a temperature below 200° C. to cause the resin to at least partially set, and the temperature may then rise to above 200° C. for the required period of time.

In some embodiments, one or more catalysts or additives may be added to facilitate or to speed up the curing. However, such catalysts or additives may not be necessary. It will be appreciated that the requirement for catalysts or additives may depend on the desired time scale for the process and on the particular resin used. Such catalysts and additives for curing resins are well-known to the person of skill in the art.

The phenolic resin mixture of the invention may advantageously allow for the amount of catalyst present to be significantly reduced, and even possibly avoided altogether.

Preferably, the amount of catalyst that is present may be less than 1 wt. % relative to the content of the phenolic resin, more preferably less than 0.5 wt. % relative to the content of the phenolic resin, such as less than 0.2 wt. %.

In some embodiments, the phenolic resin mixture may be substantially free of catalyst.

By substantially free, it is meant that the amount of any catalyst present is negligible in terms of the overall effect that it has on the phenolic resin mixture.

For the avoidance of any doubt, the term catalyst is intended to refer to additives which are known to catalyse the curing of such phenolic resins, and are known to aid B-stage curing. Traditionally, such catalysts fall into two main categories, namely acidic and basic.

Examples of acidic catalysts include, but are not limited to, one or more of hydrochloric acid, sulphuric acid and oxalic acid.

Examples of basic catalysts include, but are not limited to, one or more of ammonia, sodium hydroxide, potassium hydroxide, lithium hydroxide, rubidium hydroxide, cesium hydroxide, barium hydroxide, calcium hydroxide and ethylamine.

In a further aspect, the present invention provides a phenolic-based metamaterial or composite prepared by the methods described herein.

In a further aspect, the present invention provides a method for making a composite material comprising providing a phenolic-based metamaterial as described herein and bonding the material to a substrate.

In this way, a composite may be formed by attaching a substrate, for example a substrate as described previously herein, to the phenolic-based metamaterial, i.e. after the step of heating to a temperature greater than 200° C.

The composite may be formed by any suitable means, for example by bonding the phenolic-based metamaterial to a substrate using an adhesive or by mechanical means such as by using bolts.

A further aspect of the present invention provides a composite material prepared according to the methods described herein.

A further aspect of the present invention provides the use of a transition metal hydroxide and/or aluminium hydroxide to increase the hardness of a cured or uncured phenolic resin material, wherein the phenolic resin material comprising a transition metal hydroxide and/or aluminium hydroxide is heated to a temperature of greater than 200° C.

In preferred embodiments, the use may be performed according to embodiments of the method described previously herein.

The present invention will now be described by way of the following non-limiting examples.

### EXAMPLE 1

### Preparation of the Phenolic Resin Mixture

A phenolic resin mixture was formed according to the composition shown in Table 1 by use of a mechanical mixer until such time that the components appeared to be homogeneously combined.

The phenolic resole resin used was an aqueous resole resin having a dry weight of 74-77% and less than 0.1% free formaldehyde obtained from Satef Huttenes-Albertus as LACFEN ES 81 LF.

The Al(OH)₃ is a ground aluminium hydroxide having 99.60% Al(OH)₃ content, d10 of 3.5 μm, d50 of 23.0 μm, and d90 of 57.0 μm obtained from CellMark chemicals as ATH G200.

TABLE 1

| | Relative amount |
|---|---|
| Aqueous phenolic resole | 100 |
| resin | |
| Grey sand | 160 |
| Al(OH)₃ | 220 |
| Water | 28 |
| Black iron oxide | 2 |
| Glass fibres (chops) | 200 |

### EXAMPLE 2

The resin mixture of Example 1 was applied to an aluminium sheet having a thickness of greater than 0.5 mm and the resin was cured.

The composite was heated using a blowtorch flame (producing a temperature of around 1150° C.) applied to the surface of the aluminium sheet. After 10 to 15 minutes of heating, there was some melting of the aluminium in the local region where the flame was applied. However, the sheet as a whole substantially maintained its structural integrity and the phenolic material was structurally unaffected. The temperature at the centre of the area in which the flame is applied was measured to be 1150° C., dropping to around 600° C. at a radius of about 4 cm and then rapidly falling with increased radius. Even after more than 30 minutes heating, a layer of aluminium remained unmelted between the flame and the phenolic material.

When the aluminium sheet that was heated directly was removed from the phenolic material, the phenolic material underneath the aluminium was found to have formed a hard ceramic-like surface which was surprisingly found to have a hardness of from 300 to 600 HV on the Vickers scale. This surface was also found to conduct electricity, while the phenolic resin does not.

The phenolic material underneath the aluminium was found not to have burned and no ash was observed where temperatures of 600° C. or higher were measured. Where the temperature dropped to less than 400° C., some ash and burning of the resin was observed. Therefore, temperatures of greater than 400° C. appear to offer an advantage in forming the hard metamaterial.

At the rear surface of the cured resin from where the flame was applied, where the temperature was also lower, some ash was observed on the phenolic material.

### EXAMPLE 3

Two aluminium sheets, each having a thickness of less than 0.5 mm, were bonded together by a layer of the resin mixture of Example 1. The resin was then cured.

The composite was heated as described in Example 2. The area of the first aluminium sheet directly in contact with the flame underwent some melting in the region in which the flame was applied. However, the composite as a whole substantially maintained its structural integrity and the second aluminium sheet did not distort or melt even after more than 30 minutes of heating.

As in Example 2, the same hard ceramic-like material was observed where the phenolic material was heated. Underneath the aluminium sheet opposite to where the heating was applied, the phenolic material was observed to char but not incinerate after 15 minutes of heating.

### EXAMPLE 4

Two sheets of typical kitchen aluminium foil were attached together by a layer of the resin mixture of Example 1 and were also coated with the same resin, which was subsequently cured.

The composite was heated was heated as described in Example 2. The composite maintained structural integrity without breakage and the area of the phenolic material that was heated formed the hard ceramic-like material observed in Examples 2 and 3. The aluminium in the composite was found to be intact after the heating.

### EXAMPLE 5

Aluminium shavings were immersed in the resin mixture of Example 1, which was then cured.

This composite was heated as described in Example 2 for more than 30 minutes and there was no structural failure or burning of the resin during this heating. The phenolic material was found to form the hard ceramic-like material where heated, without burning or formation of ash.

When aluminium shavings were applied only to the surface of a layer of the resin mixture, during the same heating for 30 minutes, the composite did not yield. Upon cooling of the composite, the area in which the flame was applied was less structurally strong than for the composite having shavings immersed in the resin mixture.

### EXAMPLE 6

A layer of aluminium powder was deposited on front and rear surfaces of a layer of the resin mixture of Example 1, and the resin was cured.

When the composite was heated as described in Example 2, results similar to Example 5 were obtained, except that the area directly heated by the flame appeared to be harder in comparison.

### EXAMPLE 7

Heating the resin mixture or composite at 450° C. with a hot air stream instead of a blowtorch was also found to form a hard ceramic-like material as observed in Examples 2 to 6.

The above examples demonstrate the formation of an unusually hard ceramic-like material that results from heating the resin mixture. Surprisingly, the material exposed to higher temperatures, for example higher than 400° C., was found to result in less ash formation and burning, or even substantially no ash formation or burning, compared to material heated at lower temperatures.

1. A method for preparing a phenolic metamaterial, the method comprising providing:
(i) 1 part by weight of a phenolic resin;
(ii) 2 to 4 parts by weight of a transition metal hydroxide and/or aluminium hydroxide;
mixing components (i) and (ii) to form a phenolic resin mixture; and
heating the phenolic resin mixture at a temperature of greater than 200° C. to form the phenolic metamaterial.

2. A method according to claim 1, wherein 2.5 to 3.5 parts by weight of the metal hydroxide are provided in (ii).

3. A method according to claim 1 or claim 2, wherein the mixing is conducted in the presence of 0.2 to 1 parts by weight, relative to the phenolic resin, of a viscosity controlling agent.

4. A method according to claim 3, wherein the mixing is conducted in the presence of 0.4 to 0.9 parts by weight of the viscosity controlling agent.

5. A method according to any preceding claim, wherein the viscosity controlling agent is a liquid, preferably selected from one or more of butanol, chloroform, ethanol, water, acetonitrile, hexane and isopropyl alcohol.

6. A method according to claim 5, wherein the viscosity controlling agent is water.

7. A method according to any one of the preceding claims, wherein the phenolic resin is a phenolic resole resin, preferably a phenolic resole resin that includes less than 10% by weight of free formaldehyde, preferably less than 1% by weight, more preferably less than 0.5% by weight, for example less than 0.1% by weight.

8. A method according to any one of the preceding claims, wherein the metal hydroxide comprises particles having a particle size distribution with a D90 from 50 to 70 μm, and/or a D50 from 15 to 35 μm, and/or a D10 from 1 to 10 μm.

9. A method according to claim 8, wherein the metal hydroxide comprises particles having a particle size distribution with a D90 from 55 to 65 μm, and/or with a D50 from 20 to 30 μm, and/or with a D10 from 2 to 5 μm.

10. A method according to any one of the preceding claims, wherein the metal of the metal hydroxide is one or more of scandium, vanadium, chromium, manganese, iron, cobalt and aluminium.

11. A method according to any one of the preceding claims, wherein the metal hydroxide is of the formula M(OH)₃, wherein M is a metal.

12. A method according to any one of the preceding claims, wherein the metal hydroxide is aluminium hydroxide.

13. A method according to any one of the preceding claims, wherein the step of heating the phenolic resin mixture at a temperature of greater than 200° C. is conducted in the substantial absence of oxygen.

14. A method according to any one of the preceding claims, wherein the heating is at a temperature of around 300° C. or greater, preferably around 400° C. or greater, more preferably 500° C. or greater, for example 600° C. or greater.

15. A method according to any one of the preceding claims, wherein the phenolic resin mixture is heated for at least about one minute, preferably at least about 5 minutes, more preferably at least about 10 minutes, for example at least about 15 minutes.

16. A method according to any one of the preceding claims, further comprising applying the phenolic resin mixture to a substrate prior to heating the mixture at a temperature of greater than 200° C. to form a composite material.

17. A method according to claim 16, wherein the substrate is in the form of a sheet.

18. A method according to claim 17, wherein the phenolic resin mixture is distributed in a layer on a surface of the sheet.

19. A method according to any one of claims 16 to 18, wherein the substrate comprises a metal, polymer and/or an inorganic material.

20. A method according to claim 19, wherein the substrate comprises aluminium.

21. A method according to any one of claims 16 to 20, further comprising the step of applying a second substrate to the phenolic resin mixture.

22. A method according to claim 21, wherein the second substrate is as defined in any one of claim 17, 19 or 20.

23. A method according to claim 21 or claim 22, wherein the phenolic resin mixture is applied so as to form a layer between two aluminium sheets.

24. A method according to any one of the preceding claims, further comprising adding fibres to the phenolic resin mixture.

25. A method according to claim 24, wherein the fibres are woven or unwoven.

26. A method according to claim 24 or claim 25, wherein the fibres are in the form of a layer.

27. A method according to claim 26, wherein the fibres are in the form of a mat or fabric.

28. A method according to any one of claims 24 to 27, wherein the fibres are selected from one or more of mineral fibres (such as finely chopped glass fibre and finely divided asbestos), chopped fibres, finely chopped natural or synthetic fibres, and ground plastics and resins in the form of fibres.

29. A method according to claim 28, wherein the fibres are selected from one or more of carbon fibres, glass fibres and aramid fibres.

30. A method according to any one of the preceding claims, wherein the phenolic resin mixture has a viscosity of from 200 to 10,000 mPa·s at 20° C.

31. A method according to any one of the preceding claims, wherein the phenolic resin mixture is caused or allowed to at least partially set prior to heating the mixture at a temperature of greater than 200° C.

32. A method according to claim 31, wherein the step of causing or allowing the phenolic resin mixture to at least partially set comprises heating the mixture to a suitable temperature.

33. A method according to claim 32, wherein the phenolic resin mixture is heated to a temperature of at least 50° C.

34. A method according to claim 32 or claim 33, wherein the phenolic resin mixture is heated to a temperature between 100 and 200° C.

35. A method according to any one of claims 32 to 34, wherein the phenolic resin mixture is heated to cause the mixture to at least partially set for at least one minute.

36. A method according to any one of the preceding claims, wherein the phenolic resin mixture is moulded or shaped prior to the step of heating the phenolic resin mixture to form the phenolic metamaterial.

37. A phenolic metamaterial or a composite prepared by a method according to of any one of claims 1 to 36.

38. A method for making a composite material comprising providing a phenolic

37. rial according to claim 37 and bonding the material to a substrate.

39. A composite material prepared according to the method of claim 38.

40. Use of a transition metal hydroxide and/or aluminium hydroxide to increase the hardness of a cured or uncured phenolic resin material, wherein the phenolic resin material comprising a transition metal hydroxide and/or aluminium hydroxide is heated to a temperature of greater than 200° C.

41. Use according to claim 40, wherein the step of heating the phenolic resin mixture at a temperature of greater than 200° C. is conducted in the substantial absence of oxygen.

42. Use according to claim 40 or claim 41, wherein the heating is at a temperature of around 300° C. or greater, preferably around 400° C. or greater, more preferably 500° C. or greater, for example 600° C. or greater.

43. Use according to any one of claims 40 to 42, wherein the heating is conducted for at least about one minute, preferably at least about 5 minutes, more preferably at least about 10 minutes, for example at least about 15 minutes.

44. Use according to any one of claims 40 to 43, wherein the metal hydroxide is as defined in any one of claims 8 to 12.

45. Use according to any one of claims 40 to 44, wherein the phenolic resin mixture comprises a mixture as defined in any one of claims 1 to 7 or 24 to 35.

46. Use according to any one of claims 40 to 45, wherein the phenolic resin mixture is applied to a substrate as defined in any one of claims 16 to 23.
